(19) United States
(12) Patent Application Publication
(10) Pub. No.: US 2017/0219619 A1
(43) Pub. Date: Aug. 3, 2017

(54) ACCELEROMETER

(71) Applicant: GlobalMEMS Co., Ltd., Grand Cayman (KY)

(72) Inventors: Chun-I Chang, New Taipei City (TW); Ming-Ching Wu, Taoyuan City (TW)

(21) Appl. No.: 15/086,081

(22) Filed: Mar. 31, 2016

(30) Foreign Application Priority Data
Feb. 3, 2016 (TW) 105103639

(51) Int. Cl. G01P 15/12

(52) U.S. Cl. CPC G01P 15/123

(57) ABSTRACT

An accelerometer includes a base, two elastic portions and two masses. The base includes a supporting portion. Each of the elastic portions is connected to the supporting portion. The supporting portion is located between the two masses, the two masses are connected to the two elastic portions respectively, and the base supports the two elastic portions and the two masses merely by the supporting portion. The two masses are adapted to produce movements to enable the two elastic portions to be elastically deformed.

### CROSS-REFERENCE TO RELATED APPLICATION

This application claims the priority benefit of Taiwan application serial no. 105103639, filed on Feb. 3, 2016. The entirety of the above-mentioned patent application is hereby incorporated by reference herein and made a part of this specification.

### BACKGROUND OF THE INVENTION

1. Field of the Invention

The invention relates to an inertial sensor, and more particularly, to an accelerometer.

2. Description of Related Art

In recent years, along with development of electronic products such as smart phones, tablet PCs and somatosensory game machines, etc., micro-electromechanical system (MEMS) inertial sensors such as accelerometers and gyroscopes, etc. are widely applied in the aforementioned electronic products, and a market demand thereof has grown significantly year by year. Under intense market competition, related applications of the MEMS inertial sensors have higher demand on quality of the MEMS inertial sensors. Regarding a piezo-resistive accelerometer, acceleration of an apparatus is measured through a resistance variation amount of a component therein.

Specifically, the piezo-resistive accelerometer enables an elastic arm connected between a base and a mass thereof to be elastically deformed by a movement of the mass, and the piezo-resistive element on the elastic arm produces a resistance variation due to the elastic deformation, thereby achieving the object of sensing an acceleration. In general, two opposite ends of the mass are respectively connected to the base through the elastic arms so that the mass is supported by the base. Under this approach, the two ends of the mass are both not a free end, and thus, after the base, the mass and the elastic arms are formed integrally, there will be unexpected internal stress in the overall structure thereof, thereby affecting the acceleration sensing accuracy.

### SUMMARY OF THE INVENTION

The invention is directed to an accelerometer capable of avoiding unexpected internal stress in a base, a mass and an elastic portion and having a favorable acceleration sensing accuracy.

The accelerometer of the invention includes a base, two elastic portions and two masses. The base includes a supporting portion. Each of the elastic portions is connected to the supporting portion. The supporting portion is located between the two masses, the two masses are respectively connected to the two elastic portions, and the base supports the two elastic portions and the two masses merely by the supporting portion. The two masses are adapted to produce movements to enable the two elastic portions to be elastically deformed.

In an embodiment of the invention, the base includes a main body, the main body has an opening, the supporting portion, the two masses and the two elastic portions are located in the opening, and an inner wall of the opening is connected to the supporting portion and separated from the two masses and the two elastic portions.

In an embodiment of the invention, each of the masses has a connecting end, the connecting end is connected to the corresponding elastic portion, and each of the masses is supported by the base merely with the connecting end.

In an embodiment of the invention, each of the elastic portions includes a plurality of elastic arms, and each of the elastic arms is connected between the supporting portion and the corresponding mass.

In an embodiment of the invention, the elastic arms of each of the elastic portions at least partially surround the corresponding mass.

In an embodiment of the invention, each of the elastic portions is an elastic arm, and the elastic arm is connected between the supporting portion and the corresponding mass.

In an embodiment of the invention, each of the masses at least partially surrounds the corresponding elastic arms.

In an embodiment of the invention, each of the elastic portions has a plurality of sensing elements thereon, and each of the sensing elements is adapted to sense an elastic deformation of the corresponding elastic portion.

In an embodiment of the invention, each of the sensing elements is a piezo-resistive element.

In an embodiment of the invention, the sensing elements on each of the elastic portions are respectively adapted to sense the elastic deformation of the corresponding elastic portion with respect to a first movement direction (i.e., X-axis), a second movement direction (i.e., Y-axis) and a third movement direction (i.e., Z-axis), and the, first movement direction, the second movement direction and the third movement direction are perpendicular to each other.

In an embodiment of the invention, the sensing elements on one of the elastic portions are symmetrical to the sensing elements on another one of the elastic portions.

In view of the above, in the accelerometer of the invention, the base supports the two masses merely by the supporting portion located between the two masses, such that only one end, instead of both two ends, of each of the masses is connected to the base through the elastic portion. As such, each of the masses has a free end and each of the elastic portions has a free end, and thus, after the base, the masses and the elastic portions are formed integrally, unexpected internal stress in the overall structure thereof can be released by the free ends so that the acceleration sensing accuracy of the accelerometer is not affected by the internal stress.

To make the aforementioned and other features and advantages of the invention more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a perspective diagram of an accelerometer according to an embodiment of the invention.

FIG. 2 is a partial structure top view of the accelerometer in FIG. 1.

FIG. 3A is a partial structure perspective diagram illustrating a movement of the accelerometer in FIG. 1 along a first movement direction (i.e., X-axis).

FIG. 3B is a partial structure perspective diagram illustrating a movement of the accelerometer in FIG. 1 along a second movement direction (i.e. Y-axis).

FIG. 3C is a partial structure perspective diagram illustrating a movement of the accelerometer in FIG. 1 along a third movement direction (i.e. Z-axis).

FIG. 4A to FIG. 4C are schematic diagrams illustrating sensing elements in FIG. 2.

FIG. 5 is a partial structure perspective diagram of an accelerometer according to another embodiment of the invention.

FIG. 6 is a partial structure top view of the accelerometer in FIG. 5.

FIG. 7A is a partial structure perspective diagram illustrating a movement of the accelerometer in FIG. 5 along a first movement direction (i.e., X-axis).

FIG. 7B is a partial structure perspective diagram illustrating a movement of the accelerometer in FIG. 5 along a second movement direction (i.e. Y-axis).

FIG. 7C is a partial structure perspective diagram illustrating a movement of the accelerometer in FIG. 5 along a third movement direction (i.e. Z-axis).

FIG. 8A to FIG. 8C are schematic diagrams illustrating sensing elements in FIG. 6.

FIG. 9A to FIG. 9F are production flowcharts of the accelerometer in FIG. 1.

### DESCRIPTION OF THE EMBODIMENTS

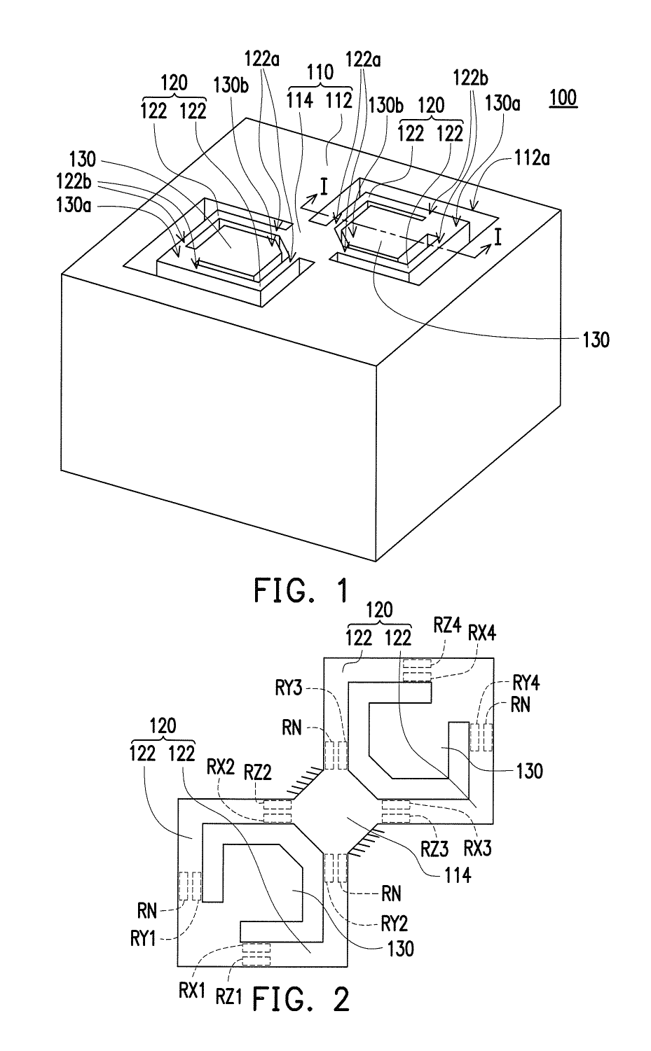

FIG. 1 is a perspective diagram of an accelerometer 100 according to an embodiment of the invention. Referring to FIG. 1, the accelerometer 100 of the present embodiment is, for example, a triaxial accelerometer manufactured by a microelectromechanical systems (MEMS) process, and includes a base 110, two elastic portions 120 and two masses 130. The base 110 includes a main body 112 and a supporting portion 114. The supporting portion 114 is located between the two masses 130, each of the elastic portions 120 has a connecting end 122a, and each of the elastic portions 120 is connected to the supporting portion 114 through the connecting end 122a. Each of the masses 130 has a connecting end 130a, and each of the connecting ends 130a is connected to the corresponding elastic portion 120. The two masses 130 are adapted to produce movements to enable the two elastic portions 120 to be elastically deformed.

In the present embodiment, the main body 112 of the base 110 has an opening 112a, the supporting portion 114, the two masses 130 and the two elastic portions 120 are located in the opening 112a, and an inner wall of the opening 112a is connected to the supporting portion 114 and separated from the two masses 130 and the two elastic portions 120. That is, the base 110 supports the two elastic portions 120 and the two masses 130 merely by the supporting portion 114 located between the two masses 130, and each of the masses 130 is supported by the base 110 merely with the connecting end 130a. As a result, only one end (i.e., the connecting end 130a), instead of both two ends, of each of the masses 130 is connected to the base 110 through the elastic portion 120. Accordingly, each of the masses 130 has a free end 130b and each of the elastic portions 120 has a free end 122b, and thus, after the base 110, the masses 130 and the elastic portion 120 are formed integrally, unexpected internal stress in the overall structure thereof can be released through the free end 130b and the free end 122b so that the acceleration sensing accuracy is not affected by the internal stress.

FIG. 2 is a partial structure top view of the accelerometer 100 in FIG. 1. As shown in FIG. 2, each of the elastic portions 120 has a plurality of sensing elements (marked as sensing elements RX1, RX2, RX3, RX4, RY1, RY2, RY3, RY4, RZ1, RZ2, RZ3, and RZ4) thereon, and configuration positions of the sensing elements on the elastic portion 120 as illustrated in FIG. 2 are merely provided as an example, such that other suitable relative positions may also be adopted. Each of the sensing elements is adapted to sense an elastic deformation of the corresponding elastic portion 120. Specifically, each of the sensing elements is, for example, a piezo-resistive element, and an elastic deformation of each of the elastic portions 120 allows a resistance variation produced by each piezo-resistive element to achieve a sensing effect, thereby enabling an acceleration of the apparatus to be calculated. Further descriptions are provided in details below.

Referring to FIG. 2, the sensing elements RX1, RX2, RY1, RY2, RZ1 and RZ2 on one of the elastic portions 120 are symmetrical to the sensing elements RX3, RX4, RY3, RY4, RZ3 and RZ4 on another one of the elastic portions 120. The sensing elements RX1, RX2, RX3 and RX4 constitute a set of Wheatstone bridges and are adapted to sense the elastic deformation of the corresponding elastic portion 120 with respect to a first movement direction (i.e., X-axis), the sensing elements RY1, RY2, RY3 and RY4 constitute a set of Wheatstone bridges and are adapted to sense the elastic deformation of the corresponding elastic portion 120 with respect to a second movement direction (i.e., Y-axis), and the sensing elements RZ1, RZ2, RZ3 and RZ4 constitute a set of Wheatstone bridges and are adapted to sense the elastic deformation of the corresponding elastic portion 120 with respect to a third movement direction (i.e., Z-axis), so as to perform a triaxial sensing for calculating an accurate acceleration value. The first movement direction, the second movement direction and the third movement direction are perpendicular to each other. Sensing principles of the sensing elements with respect to different movement directions are further explained in below, respectively.

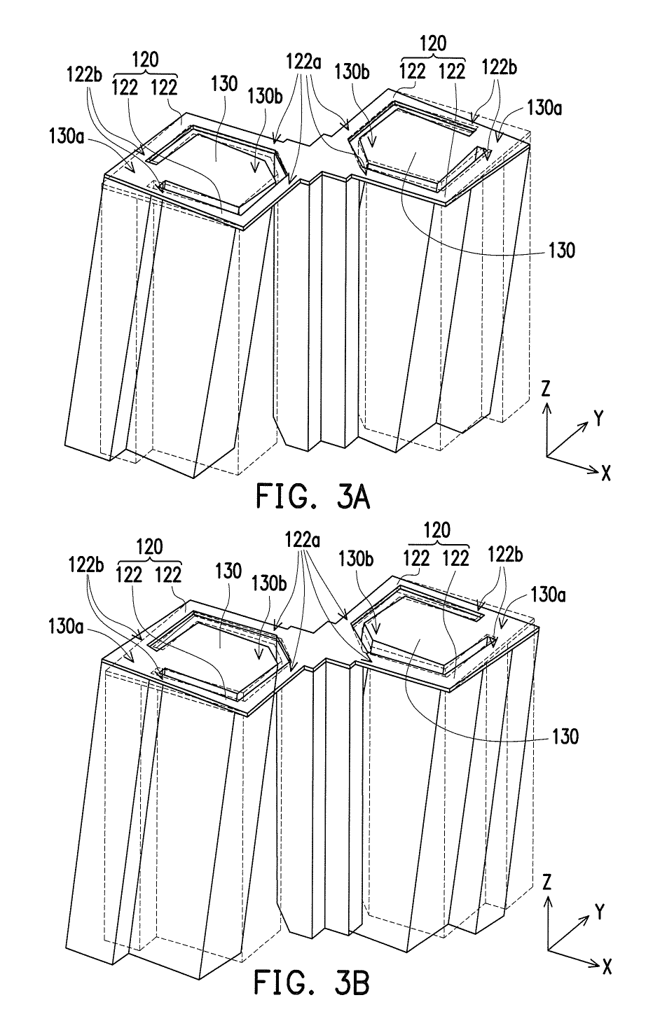

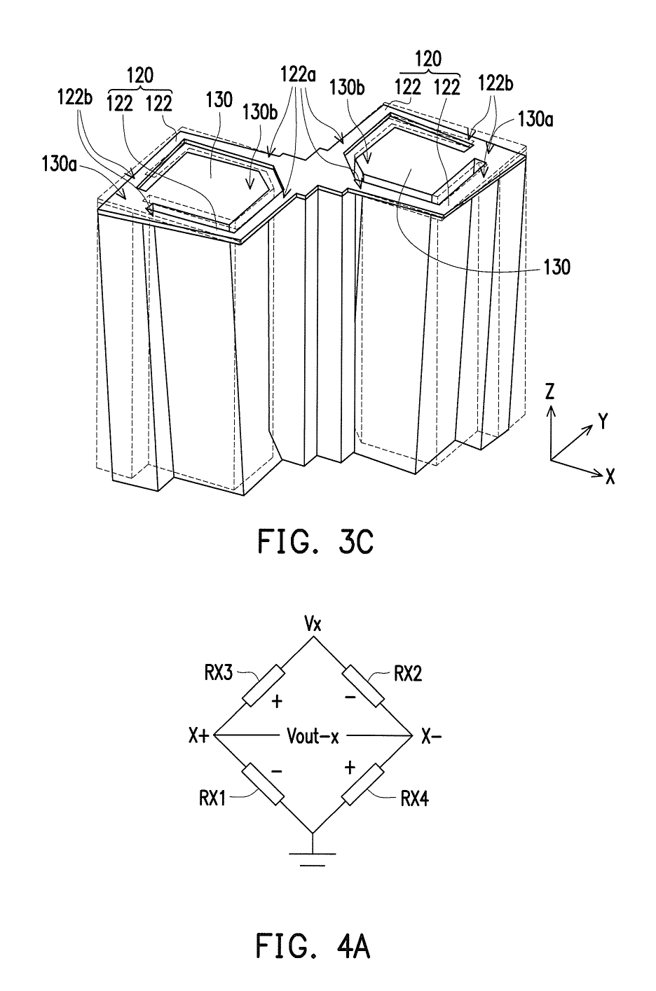

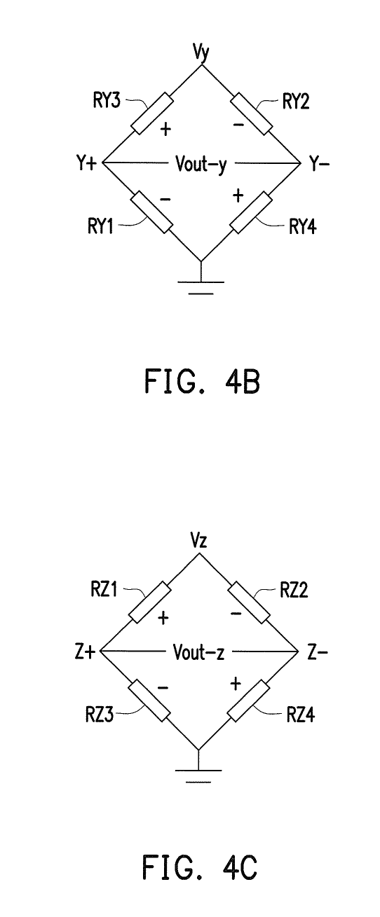

FIG. 3A is a partial structure perspective diagram illustrating a movement of the accelerometer 100 in FIG. 1 along the first movement direction (i.e., X-axis). FIG. 3B is a partial structure perspective diagram illustrating a movement of the accelerometer 100 in FIG. 1 along the second movement direction (i.e. Y-axis). FIG. 3C is a partial structure perspective diagram illustrating a movement of the accelerometer 100 in FIG. 1 along the third movement direction (i.e. Z-axis). FIG. 4A to FIG. 4C are schematic diagrams illustrating the sensing elements in FIG. 2, wherein Vx, Vy and Vz are input voltages. When accelerometer 100 of FIG. 1 moves along the first movement direction X (as marked in FIG. 3A) to enable each of the masses 130 to move in a manner as shown in FIG. 3A, each of the elastic portions 120 thus produces an elastic deformation, as shown in FIG. 4A, to enable the sensing elements RX1 and RX2 to produce negative resistance variations and the sensing elements RX3 and RX4 to produce positive resistance variations, so as to output a sense voltage Vout-x between X+ and X− for obtaining an acceleration of the apparatus along the first movement direction X.

Similarly, when the accelerometer 100 of FIG. 1 moves along the second movement direction Y (as marked in FIG. 3B) perpendicular to the first movement direction X to enable each of the masses 130 to move in a manner as shown in FIG. 3B, each of the elastic portions 120 thus produces an elastic deformation, as shown in FIG. 4B, to enable the sensing elements RY1 and RY2 to produce negative resistance variations and the sensing elements RY3 and RY4 to produce positive resistance variations, so as to output a sense voltage Vout-y between Y+ and Y− for obtaining an acceleration of the apparatus along the second movement direction Y.

Similarly, when the accelerometer 100 of FIG. 1 moves along the third movement direction Z (as marked in FIG. 3C) perpendicular to the first movement direction X and the second movement direction Y to enable each of the masses 130 to move in a manner as shown in FIG. 3C, each of the elastic portions 120 thus produces an elastic deformation, as shown in FIG. 4C, to enable the sensing elements RZ2 and RZ3 to produce negative resistance variations and the sensing elements RZ1 and RZ4 to produce positive resistance variations, so as to output a sense voltage Vout-z between Z+ and Z− for obtaining an acceleration of the apparatus along the third movement direction Z.

Referring to FIG. 2, each of the elastic portions 120 of the present embodiment further has sensing elements RN thereon, and the sensing elements RN are, for example, not used for sensing but for forming a symmetrical relationship with the other sensing elements in terms of structure so that the overall structure can be more balanced. In other embodiments, the sensing elements RN can also not be disposed.

In the present embodiment, each of the elastic portions 120 includes a plurality of elastic arms 122, each of the elastic arms 122 is connected between the supporting portion 114 and the corresponding mass 130, and the elastic anus 122 at least partially surround the corresponding mass 130. However, the invention does not limit the number of the elastic arms of the elastic portion and their relative positions with the masses; and further descriptions accompanied by the drawings are provided in below.

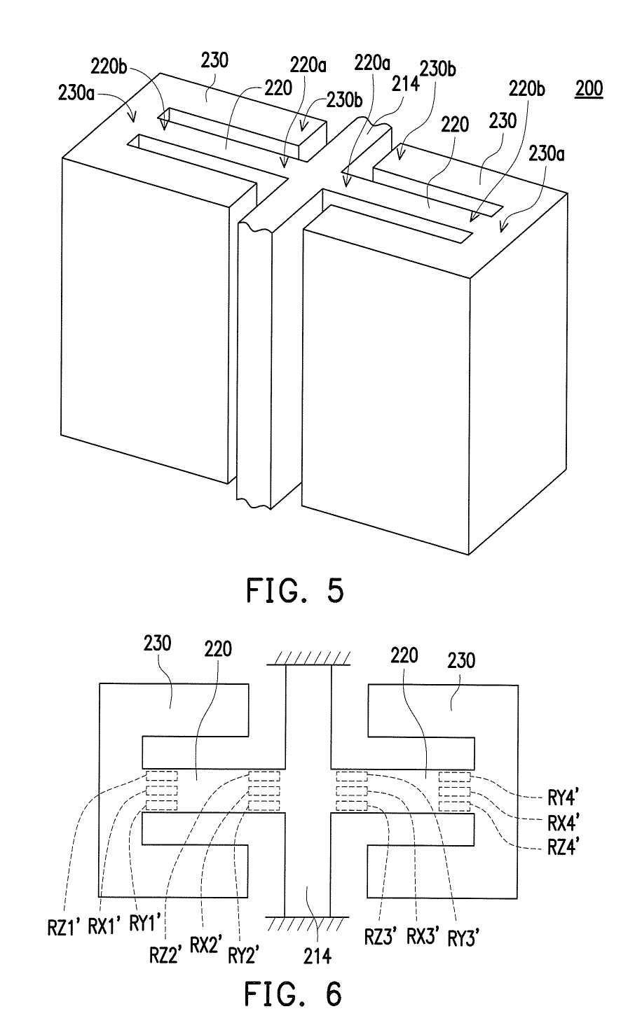

FIG. 5 is a partial structure perspective diagram of an accelerometer 200 according to another embodiment of the invention. In the accelerometer 200 of FIG. 5, configuration and actuation means of a supporting portion 214, elastic portions 220, masses 230, connecting ends 230a, free ends 230b, connecting ends 220a, and free ends 220b are similar to the configuration and actuation means of the supporting portion 114, the elastic portions 120, the masses 130, the connecting ends 130a, the free ends 130b, the connecting ends 122a, and the free ends 122b of FIG. 1, and thus will not be repeated herein. Differences between the accelerometer 200 and the accelerometer 100 lie in that, each of the elastic portions 220 is an elastic arm, the elastic arm is connected between the supporting portion 214 and the corresponding mass 230, and each of the masses 230 at least partially surround the corresponding elastic arms.

FIG. 6 is a partial structure top view of the accelerometer 200 in FIG. 5. As shown in FIG. 6, each of the elastic portions 220 has a plurality of sensing elements (marked by sensing elements RX1′, RX2′, RX3′, RX4′, RY1′, RY2′, RY3′, RY4′, RZ1′, RZ2′, RZ3′, and RZ4′) thereon, and configuration positions of the sensing elements on the elastic portion 220 as illustrated in FIG. 5 are merely provided as an example, such that other suitable relative positions may also be adopted. Each of the sensing elements is adapted to sense an elastic deformation of the corresponding elastic portion 220. Specifically, each of the sensing elements is, for example, piezo-resistive element, and the elastic deformation of the elastic portion 220 allows the piezo-resistive element to produce a resistance variation to achieve the sensing effect, thereby enabling an acceleration of the apparatus to be calculated. Further descriptions are provided in details below.

Referring to FIG. 6, the sensing elements RX1′, RX2′, RY1′, RY2′, RZ1′, and RZ2′ on one of the elastic portions 220 are symmetrical to the sensing elements RX3′, RX4′, RY3′, RY4′, RZ3′, and RZ4′ on another one of the elastic portions 220. The sensing elements RX1′, RX2′, RX3′, and RX4′ constitute a set of Wheatstone bridges and are adapted to sense the elastic deformation of the corresponding elastic portion 220 with respect to a first movement direction (i.e., X-axis), the sensing elements RY1′, RY2′, RY3′, and RY4′ constitute a set of Wheatstone bridges and are adapted to sense the elastic deformation of the corresponding elastic portion 220 with respect to a second movement direction (i.e. Y-axis), and the sensing elements RZ1′, RZ2′, RZ3′, and RZ4′ constitute a set of Wheatstone bridges and are adapted to sense the elastic deformation of the corresponding elastic portion 120 with respect to a third movement direction (i.e., Z-axis), so as to perform a triaxial sensing for calculating an accurate acceleration value. The first movement direction, the second movement direction and the third movement direction are perpendicular to each other. Sensing principles of the sensing elements with respect to different movement directions are further explained in below, respectively.

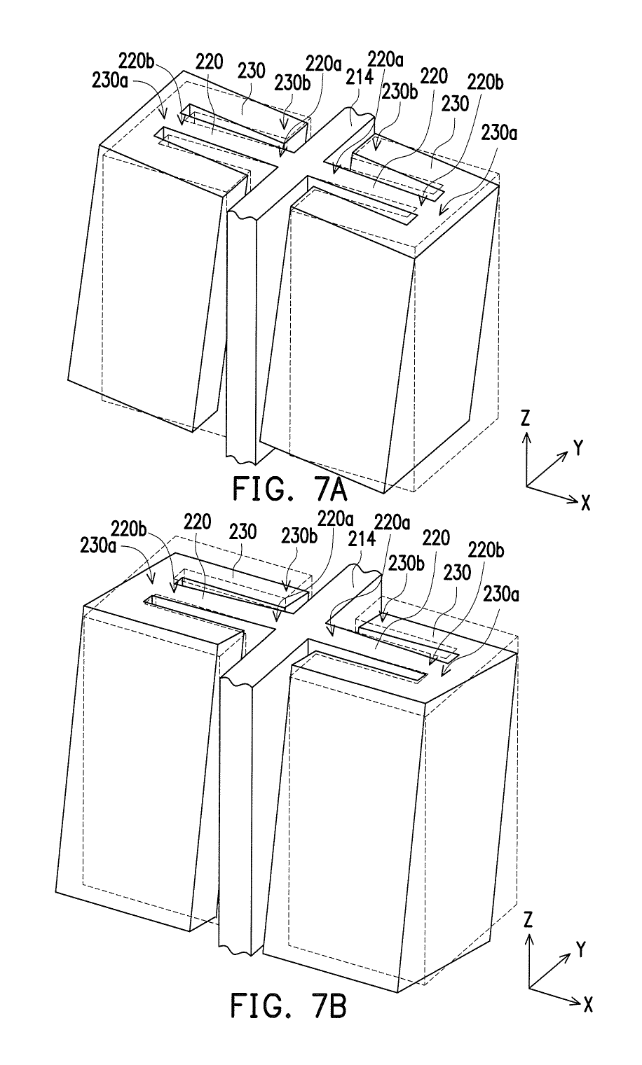

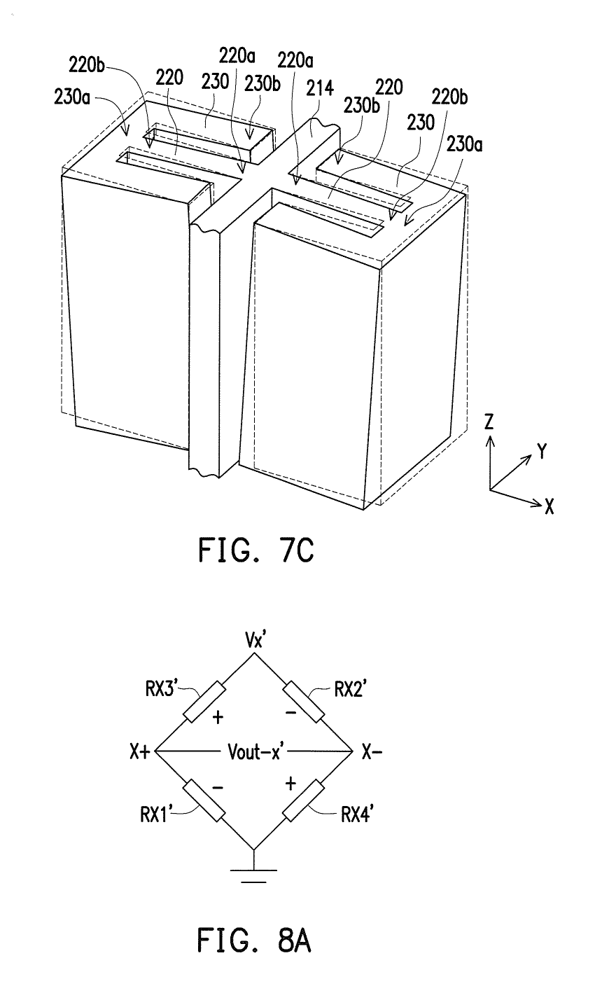

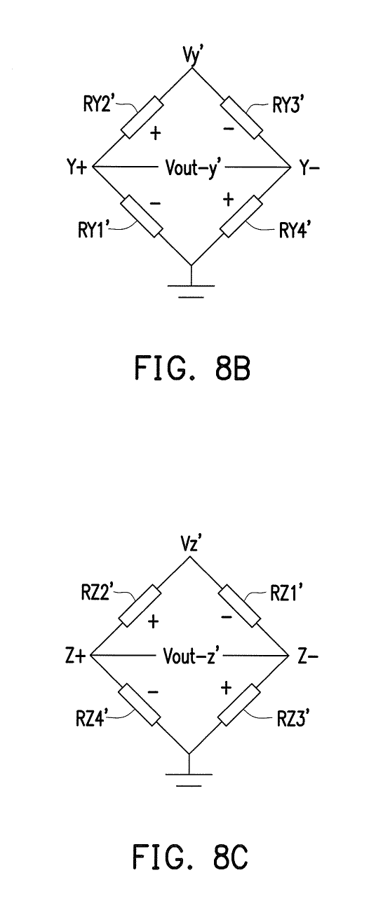

FIG. 7A is a partial structure perspective diagram illustrating a movement of the accelerometer 200 in FIG. 5 along the first movement direction. FIG. 7B is a partial structure perspective diagram illustrating a movement of the accelerometer 200 in FIG. 5 along the second movement direction. FIG. 7C is a partial structure perspective diagram illustrating a movement of the accelerometer 200 in FIG. 5 along the third movement direction. FIG. 8A to FIG. 8C are schematic diagrams illustrating the sensing elements in FIG. 6, wherein Vx′, Vy′ and Vz′ are input voltages. When the accelerometer 200 of FIG. 5 moves along the first movement direction X (as marked in FIG. 7A) to enable each of the masses 230 to move in a manner as shown in FIG. 7A, each of the elastic portions 220 thus produces an elastic deformation, as shown in FIG. 8A, to enable the sensing elements RX1′ and RX2′ to produce negative resistance variations and the sensing elements RX3′ and RX4′ to produce positive resistance variations, so as to output a sense voltage Vout-x′ between X+ and X− for obtaining an acceleration of the apparatus along the first movement direction X.

Similarly, when the accelerometer 200 of FIG. 5 moves along the second movement direction Y (as marked in FIG. 7B) perpendicular to the first movement direction X to enable each of the masses 230 to move in a manner as shown in FIG. 7B, each of the elastic portions 220 thus produces an elastic deformation, as shown in FIG. 8B, to enable the sensing elements RY1′ and RY3′ to produce negative resistance variations and the sensing elements RY2′ and RY4′ to produce positive resistance variation, so as to output a sense voltage Vout-y′ between Y+ and Y− for obtaining an acceleration of the apparatus along the second movement direction Y.

Similarly, when the accelerometer 200 of FIG. 5 moves along the third movement direction Z (as marked in FIG. 7C) perpendicular to the first movement direction X and the second movement direction Y to enable each of the masses 230 to move in a manner as shown in FIG. 7C, each of the elastic portions 220 thus produces an elastic deformation, as shown in FIG. 8C, to enable the sensing elements RZ1′ and RZ4′ to produce negative resistance variations and the sensing elements RZ2′ and RZ3′ to produce positive resistance variations, so as to output a sense voltage Vout-z′ between Z+ and Z− for obtaining an acceleration of the apparatus along the third movement direction Z.

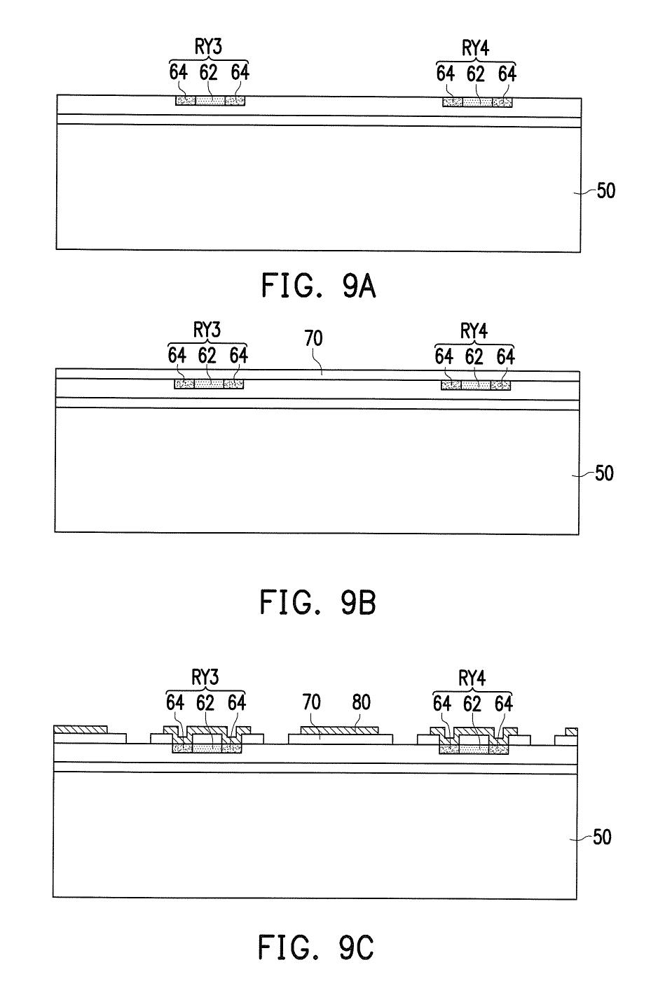

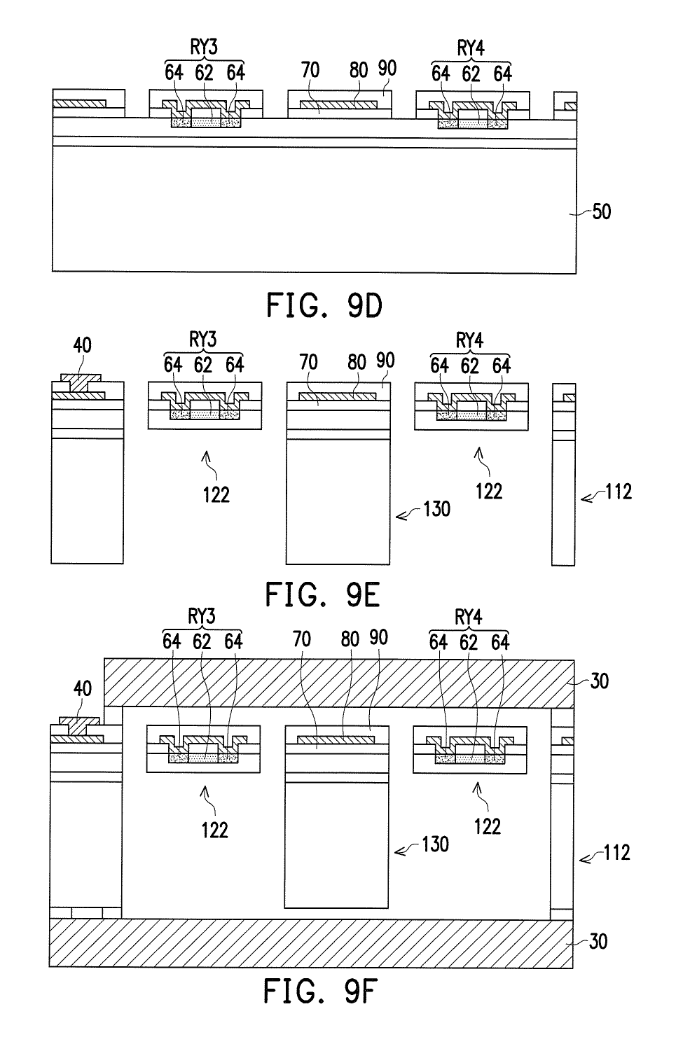

In the following, using the accelerometer 100 of FIG. 1 as an example, a production process thereof will be explained. FIG. 9A to FIG. 9F are production flowcharts of the accelerometer in FIG. 1, which are corresponded to a cross-section of the accelerometer 100 in FIG. 1 along a line I-I. Firstly, as shown in FIG. 9A, the sensing elements (sensing elements RY3 and RY4 are illustrated) are formed on a substrate 50, each of the sensing elements is constituted by a piezo-resistive material 62 and two heavily doped wires 64 located at two sides of the piezo-resistive material 62. Next, as shown in FIG. 9B, an insulation layer 70 is formed on the substrate 50, and the insulation layer 70 covers the piezo-resistive material 62 and the heavily doped wires 64. As shown in FIG. 9C, the insulation layer 70 is patterned to expose the heavily doped wires 64, a patterned circuit layer 80 is formed on the insulation layer 70, and the patterned circuit layer 80 is connected with the heavily doped wires 64. As shown in FIG. 9D, another insulation layer 90 is formed on the insulation layer 70, and the insulation layer 90 covers the patterned circuit layer 80. As shown in FIG. 9E, a pad 40 is formed on a portion of the patterned circuit layer 80 exposed by the insulation layer 90, so as to electrically connected with the outside through the pad 40. In addition, as shown in FIG. 9E, partial structures of the substrate 50 are removed to form the elastic arms 122, the mass 130 and the main body 112. Moreover, covering structures 30, as shown in FIG. 9F, may further be formed above and below the structure shown in FIG. 9E such that the elastic arms 122 and the mass 130 can be hidden between the covering structures 30.

In summary, in the accelerometer of the invention, the base supports the two masses merely by the supporting portion located between the two masses, such that only one end, instead of both two ends, of each of the masses is connected to the base through the elastic portion. As such, each of the masses has one free end and each of the elastic portions has one free end, and thus, after the base, the masses and the elastic portions are formed integrally, unexpected internal stress in the overall structure thereof can be released by the free ends so that the acceleration sensing accuracy of the accelerometer is not affected by the internal stress.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An accelerometer, comprising:
a base, comprising a supporting portion;
two elastic portions, each of the elastic portions being connected to the supporting portion; and
two masses, the supporting portion being located between the two masses, the two masses respectively connected to the two elastic portions, the base supporting the two elastic portions and the two masses merely by the supporting portion, and the two masses being adapted to produce movements to enable the two elastic portions to be elastically deformed.

2. The accelerometer as recited in claim 1, wherein the base comprises a main body, the main body has an opening, the supporting portion, the two masses and the two elastic portions are located in the opening, an inner wall of the opening is connected to the supporting portion and separated from the two masses and the two elastic portions.

3. The accelerometer as recited in claim 1, wherein each of the masses has a connecting end, the connecting end is connected to the corresponding elastic portion, and each of the masses is supported by the base merely with the connecting end.

4. The accelerometer as recited in claim 1, wherein each of the elastic portions comprises a plurality of elastic arms, and each of the elastic arms is connected between the supporting portion and the corresponding mass.

5. The accelerometer as recited in claim 4, wherein the elastic arms of each of the elastic portions at least partially surround the corresponding mass.

6. The accelerometer as recited in claim 1, wherein each of the elastic portions is an elastic arm, and the elastic arm is connected between the supporting portion and the corresponding mass.

7. The accelerometer as recited in claim 6, wherein each of the masses at least partially surrounds the corresponding elastic arm.

8. The accelerometer as recited in claim 1, wherein each of the elastic portions has a plurality of sensing elements thereon, and each of the sensing elements is adapted to sense an elastic deformation of the corresponding elastic portion.

9. The accelerometer as recited in claim 8, wherein each of the sensing elements is a piezo-resistive element.

10. The accelerometer as recited in claim 8, wherein the sensing elements on each of the elastic portions are respectively adapted to sense the elastic deformation of the corresponding elastic portion with respect to a first movement direction, a second movement direction and a third movement direction, and the first movement direction, the second movement direction and the third movement direction are perpendicular to each other.

11. The accelerometer as recited in claim 8, wherein the sensing elements on one of the elastic portions are symmetrical to the sensing elements on another one of the elastic portions.
